(19) United States
(12) Patent Application Publication
(10) Pub. No.: US 2023/0120747 A1
(43) Pub. Date: Apr. 20, 2023

(54) GREY MARKET ORDERS DETECTION

(71) Applicant: EMC IP Holding Company LLC, Hopkinton, MA (US)

(72) Inventors: Noga Gershon, Beer Sheva (IL); Amihai Savir, Newton, MA (US); Or Herman-Saffar, Ofakim (IL)

(21) Appl. No.: 17/451,524

(22) Filed: Oct. 20, 2021

(51) Int. Cl. G06Q 30/06; G06F 16/906; G06N 7/00

(52) U.S. Cl. CPC G06Q 30/0609; G06F 16/906; G06Q 30/0635; G06N 7/005

(57) ABSTRACT

One example method includes detecting grey market orders with a detection model. Data from historical orders, which include confirmed grey market orders, can be clustered based on engineered features of the data such that similar orders are clustered together. A new order can be assigned to one of the clusters and a similarity score of the new order to the orders in the assigned cluster can be generated. The score reflects the likelihood that the new order is a grey market order. Action can be taken on the new order based on the score.

### FIELD OF THE INVENTION

Embodiments of the present invention generally relate to detecting grey market orders. More particularly, at least some embodiments of the invention relate to systems, hardware, software, computer-readable media, and methods for detecting grey market orders and for acting on the detection of grey market orders.

### BACKGROUND

The term “grey market” often refers to the trade of commodities through distribution channels that are not authorized by the original manufacturer. A grey market order generally refers to an order where the purchased product is resold in an unauthorized manner. The initial purchase, however, may be through an authorized channel. For example, an existing customer may make a purchase and may receive a substantial discount. If the customer then sells the purchased products, the original order is a grey market order because the product was resold in an unauthorized manner.

In other words, unauthorized resellers are able to purchase the product at a price that allows them to make a profit by reselling the product at prices that are attractive to other consumers. This impacts the manufacturer or original seller in many ways, including financially.

In addition to the financial impact of the grey market, grey market sales can lead to problems for a brand. For example, the availability of product in the grey market may cause customers to purchase from an unauthorized reseller. However, these types of sales in the grey market may come with incompatible equipment, instructions in a foreign language, or the like. Unfortunately, the manufacturer and/or authorized resellers are often blamed for these problems. Plus, customers may also begin to expect the discount available in the grey market.

Currently, grey market orders are detected after the fact. There is no ability to detect when a purchaser (who may or may not be the reseller) is going to resell the purchased product in an unauthorized manner at the time the order is placed. In fact, grey market orders may not be detected for some time.

One of the ways companies detect grey market orders is by using a buy-back program. A manufacturer can purchase products that are sold through an unauthorized channel and trace the product to the account that made the purchase. The characteristics of that grey market order can then be determined. However, this does not necessarily help the manufacturer or original seller detect a grey market order at the time of the original purchase. Currently, the ability to detect grey market orders is a difficult and manual process and there is no ability to take action against grey market orders at the time the order is placed or while the order is being prepared.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a model configured to detect grey market orders and the ability to update or retrain the model based on feedback regarding the model's output;

FIG. 2 discloses aspects of a clustering engine and an analytic engine of a model configured to detect grey market orders;

FIG. 3 discloses aspects of a method for detecting a grey market order; and

FIG. 4 discloses aspects of a physical computing device or computing system.

### DETAILED DESCRIPTION OF SOME EXAMPLE EMBODIMENTS

Embodiments of the present invention generally relate to operations related to purchasing products and services. More particularly, at least some embodiments of the invention relate to systems, hardware, software, computer-readable media, and methods for detecting grey market orders and for acting on grey market orders.

Grey market orders relate, by way of example only, to a customer or partner that may pursue a goal of obtaining a substantial discount on product from an authorized seller or manufacturer and instead of using the product, the customer or partner then resells the product at a higher price. Grey market orders cannot be identified using rules. Nonetheless, identifying grey market orders is important for various reasons including preventing margin leakage (lost profits) and to prevent damage to the seller's brand.

The ability to detect a grey market order while the order is being placed or generated allows a seller to take actions prior to completing the order. Embodiments of the invention relate to, in addition to detecting a grey order, taking actions on the grey market order such as preventing the order, not approving the order, adjusting the LU order (e.g., in terms of quantity, price, discount applied), or the like or combination thereof. Embodiments of the invention thus relate to detecting grey orders at the time the order is made and then taking an action.

In some embodiments, machine learning plays a role in detecting grey market orders. An anomaly detection engine (e.g., a machine learning model) may include multiple engines or components and can be trained with historical data (data associated with legitimate and/or grey market orders). The data used to train a model may include characteristics or features of the historical orders. The features may be extracted or generated from the raw order data. Embodiments of the invention may also discover which of the features are more relevant in distinguishing or differentiating grey market orders from legitimate orders.

Some features may be engineered to capture or identify behavior in an order or in an account that indicates the occurrence of grey market activity. Embodiments of the invention can generate a score for a new order based, by way of example only, on the similarity of the new order to historical orders using features that are built or engineered to identify grey market activity.

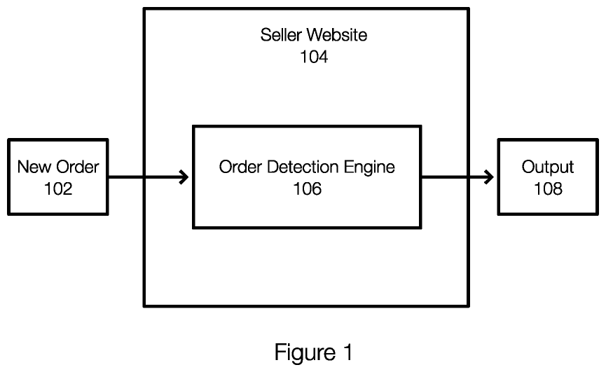

FIG. 1 discloses aspects of an order detection engine configured to detect grey market orders at the time the order is placed. As illustrated, a new order 102 may be received, for example, at a seller website 104. The new order 102 is then processed by the order detection engine 106. The order detection engine 106 is configured to determine whether the new order 102 is a grey market order. More specifically, the order detection engine 106 may generate an output 108 indicating the likelihood that the new order 102 is a grey market order.

More generally, the anomaly detection engine 106 is configured to identify grey market quotes or orders automatically by generating a score for the order as an output 108. For example, the output 108 or score may range between a value of 0 and 100. In another example, the score may be between 0 and 1. A higher score may indicate a higher likelihood that the new order 102 is a grey market order. In one example, a threshold score or output 108 may be set. New orders that have a score above the threshold score may be subjected to further scrutiny. More specifically, some action may be taken for orders associated with a score that exceeds a threshold score. If the score of the new order is below the threshold score, the new order may be allowed to proceed.

The order detection engine 106 generates a score for the new order 102 based, at least in part, using data from historical orders. As previously stated, grey orders, conventionally, cannot be determined at the time the order is submitted. However, grey orders can be detected after the fact conventionally. Conventionally, grey market orders are identified by examining past order using rules to narrow down the order to a more manageable set. The remaining orders, when possible, are manually reviewed. However, many orders are unlabeled and embodiments of the invention may use an unsupervised approach. A buy-back program may also be performed to purchase product sold through unauthorized channels. This allows the label to be traced to the account that made the purchase. Thus, data from historical orders can be reviewed to identify which orders were grey market orders and which orders were not grey market orders.

The order detection engine 106 may process the historical data, which includes historical account information (specific accounts or customers and their orders), in order to cluster the accounts/orders. By clustering the historical account information, new orders can be compared to specific clusters. In other words, this allows a new order to be compared to a cluster of orders that are most similar to the new order. More specifically, embodiments of the invention can further compare the new order to orders that are similar to the past orders of the specific account. In other words, when a new order is received from an account, clustering allows the new order can be compared to orders that are similar to the orders that the current account has made in the past. Clustering can eliminate errors such as false positives that may arise if the new order is compared to all orders.

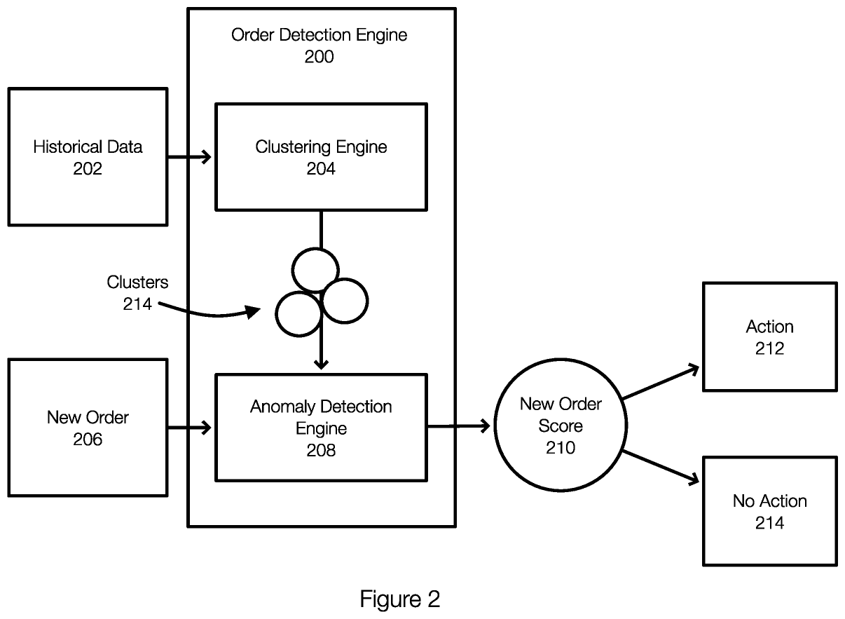

FIG. 2 discloses aspects of a grey order detection system. The order detection engine 200 may include various engines including, by way of example only, a clustering engine 204 and an anomaly detection engine 208. The order detection engine 200 may use statistical methods, probabilistic models, and machine learning methods to automatically detect grey market orders. In one example, a new order 206 is input to the order detection engine 200 and a new order score 210 is output by the order detection engine 200.

Depending on a value of the new order 210, an action 212 is taken or no action 214 is taken. In one example, action 212 is taken if the new order score 210 is above a threshold value.

In one example, the clustering engine 204 is configured to process historical data 202. The historical data 202 may include data for legitimate orders and/or for grey market orders. The orders in the historical data may also be associated with corresponding accounts or customers. The clustering engine 204 is configured to generate clusters 214 from the historical data 202. The clustering engine 204 groups the historical data 202, which may include confirmed grey market orders, into the clusters 214 using various features. Thus, each of the clusters 214 represents a group of similar orders or similar accounts or similar accounts and/or order. By clustering the historical data 202 into clusters 214, new orders 206 can be assigned or associated with a specific cluster and evaluated in the context of the orders in the associated cluster.

More specifically, the historical data 202 may be processed to generate features that are input to the clustering engine 204 and that were used to cluster the historical data 202. In one example, the features are engineered to describe account properties and purchase patterns over a certain period. This information is provided to the clustering engine 204 in order to determine which accounts should be examined together or in order to cluster the historical data 202.

The raw and engineered features, for clustering purposes, may include, by way of example and not limitation, account industry, number of purchases, purchased LOBs (Line of Business) and quantity, average time between purchases, direct purchases, purchase channel, commercial revenue, enterprise revenue, median purchase revenue, standard deviation of purchase revenue, number of employees, and buy power (amount of goods and services of a company that can be purchased with a unit of currency).

These features can be generated, extracted, or derived from the raw historical data 202 and used by the clustering engine 204 to generate clusters 214. In one example, the clustering engine 204 is an unsupervised learning task that divides a set of data points into several groups in such a way that data points assigned to the same group of cluster are more similar to data points in the same group than those in other groups. Example clustering techniques include k-means, Gaussian mixture model, or hierarchical clustering.

For example, a gaussian mixture model (GMM) is a probabilistic model that assumes instances are generated from a mixture of several gaussian distributions whose parameters are unknown. GMM can be used to perform soft and/or hard clustering. To perform hard clustering, the model assigns data points to the multivariate normal distribution that maximizes the posterior probability based on the data. Hard clustering assigns each data point to exactly one cluster. Soft clustering assigns a score to each data point describing the association strength for each cluster. GMM clustering can support clusters with varied sizes and correlations.

Generally, GMM is performed by the clustering engine 204 and may begin by determining the number of clusters. This may be based on an understanding of the business and may be determined by a user or based determined from an analysis of the historical data 202. The gaussian distribution parameters for each cluster are randomly initialized. Next, given the gaussian distributions for each cluster, the probability that each data point belongs to a certain cluster is calculated. The closer the data point is to the center of the cluster, the more likely the data point belongs to that cluster.

Based on these probabilities, a new set of parameters is calculated in such a way that the probabilities of the data points within the clusters are maximized. The new parameters are computed using a weighted sum of the data points, where the weights are the probabilities of the data points belonging to a particular cluster. These steps can be repeated iteratively until convergence is reached. Thus, the clustering engine 204 can generate clusters 214 from the historical data 202. As new orders are continually processed, the historical data 202 and the clusters 214 can be continually updated over time.

The anomaly detection engine 208 can use the clusters 214 when evaluating the new order 206. When the new order 206 is received, engineered features for the new order 206 (and/or the associated account) may be generated. The features may include, by way of example and not limitation, product, quantity, price, discount, time since last purchase of the same product, last order quantity different in percentage, mean and median of previous purchase quantities, and average time between purchases.

When a new order is received, the new order 206 is clustered by the clustering engine 204 in order to determine which cluster 214 is to be used for determining whether the new order 206 is a grey market order. Next, the features of the new order 206 are determined and the anomaly detection engine 208 determines how similar the new order 206 is to the orders/accounts in the relevant cluster.

In one example, the similarity of the new order 206 to the orders in the relevant cluster is determined using an unsupervised KNN (K Nearest Neighbor) process. KNN is a non-parametric supervised method to classify an instance (the order 206) to its neighbors (e.g., the orders in the relevant cluster). The anomaly detection engine 208 determine the distances between the new order and the k closest neighbors. When most of the neighbors are close, this suggests that the new order 206 (or data point) is not anomalous or is not a grey market order. When the closest neighbors are far away from the new order 206, this suggests that the new order 206 is anomalous or is a grey market order.

In one example, k may be relatively large (e.g., k=50). However, the number selected for k may be larger or smaller and may vary. By generating the new order score 210 using a large number of neighbors, the confidence in the new order score 210 is increased.

In one example, the distance between two data points (or between the new order 206 and its neighbors in the relevant cluster), is determined using a cosine similarity. Cosine similarity is a measure of similarity between two features vectors. Two vectors with the same orientation have a cosine similarity of 1. Two vectors oriented at 90 degrees relative to each other have a similarity of 0. Two vectors diametrically opposed have a similarity of −1. These values may be independent of their magnitude. The cosine similarity is particularly used in positive spaces, where the outcome is bounded in [0, 1].

Thus:

$$similarity = \frac{{{\sum }_{i = 1}}^{n} {A}_{i} {B}_{i}}{\sqrt{{{\sum }_{i = 1}}^{n} {A}_{i}^{2}} \sqrt{{{\sum }_{i = 1}}^{n} {B}_{i}^{2}}}$$

In one example, the similarity threshold is set to 0.5. Orders whose score is above the similarity threshold are more likely to be grey market orders than orders whose similarity score is below the similarity threshold. However, the similarity threshold can change. For example, the similarity threshold may change based on the number or new orders or quotes and can be reviewed periodically. In one example, low capacity may decrease the threshold while high capacity may increase the threshold.

As previously stated, the features used for clustering are selected such that similar accounts are clustered or such that similar accounts/orders are clustered together. In other words, features generated from the historical data 202 are input to the clustering engine 204 and the clustering engine 204 then produces clusters 214. When processing a new order, the new order is assigned to or associated with one of the clusters based on similar features and an order score (the similarity score) can be generated based, at least in part, the similarity of the new order to orders in the cluster to which the new order is assigned.

In one example, the historical data 202 may include only known non-grey market orders. This helps ensure that grey market orders are sufficiently far from known non-grey market orders. Orders that are known to be grey market orders or that are labeled as such are not included in the clustering. Because not all grey market orders are labeled, some grey market orders may be involved in the clustering process. However, the number is expected to be small and does not have substantial impact on the clustering output.

When a new order 206 is generated or made, the new order 206 is processed, similarly to the historical data 202 to generate the same features. The anomaly detection engine 208 can use the clustering engine 204 to assign or associate the new order 206 to one of the clusters 214 based on the features of the new order 206.

The anomaly detection engine 208 takes the characteristics of or extracts the features of a new order 206 and returns a score 210 indicating a probability or likelihood that the new order 206 is a grey market order.

The anomaly detection engine 208 can detect orders that are similar to well-known or confirmed historical grey market orders or detect orders that are not similar to non grey market orders. Further, this allows grey market orders to be detected before the orders are approved or completed such that appropriate action can be taken regarding the order. This further allows the time and cost of pricing analysts to be used more effectively and more efficiently and to focus on orders that are more likely to be grey market orders and to focus on the features or characteristics that led to the determination.

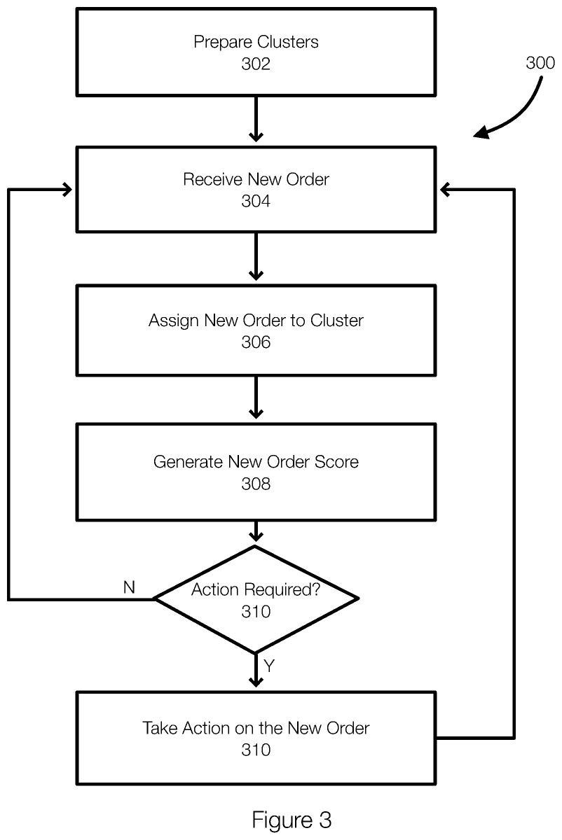

FIG. 3 discloses aspects of a method for detecting grey market orders. Some of the elements in the method 300 may be performed as needed or less often than other elements. For example, once a model such as the order detection engine 200 is trained on historical data and clusters are generated, regenerating clusters or changing the number of clusters or updating the model with new historical data, may be performed less frequently.

In this example of the method 300, clusters are prepared 302 or generated. Clusters are prepared from historical data or, more specifically, from features that have been extracted or engineered from the historical data. These features allow historical accounts and/or orders (quotes) to be clustered. The historical data may be clustered using probabilistic models such as gaussian mixed models.

The clusters are configured to represent similar accounts and/or orders. For example, similar may be based on different features and the clusters can group these different types of orders into appropriate clusters at least for grey market order detection. The number of clusters can be user determined or automatically determined.

Once the clusters have been generated, the detection model, which may also include an analytic engine such as an anomaly detection engine, may receive 304 a new order. The new order is assigned 306 to a cluster (e.g., by the clustering engine). Assigning 306 the new order to a cluster may include extracting the features of the new order (e.g., the same features used for clustering) and then assigning the new order to the cluster that includes the most similar orders to the new order.

Once assigned to a cluster, a score is generated 308 for the new order by determining a similarity score. The similarity score may be generated using an unsupervised KNN algorithm. The similarity score is output and represents the likelihood that the new order is a grey market order. The score may also be associated with metadata identifying the most relevant features that contributed to the generated score.

A determination is them made as to whether action on the new order is required 310. If the similarity score is below a threshold score (N at 310), no action is taken and the method may wait for a new order. If the similarity score is above a threshold score (Y at 310), action may then be taken 310 on the new order.

Thus, if the score suggests that the order is legitimate, no action may be taken and the order may be accepted. If the score suggests that the order is a grey market order, actions may be taken 310 such as cancelling the order, changing pricing in the order, limiting quantities in the order, requiring the purchaser to communicate with the seller, or the like or combination thereof.

Embodiments of the invention, such as the examples disclosed herein, may be beneficial in a variety of respects. For example, and as will be apparent from the present disclosure, one or more embodiments of the invention may provide one or more advantageous and unexpected effects, in any combination. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, order detection operations. Such order detection operations may include, but are not limited to, grey market detection operations, clustering operations, feature engineering operations, feature extraction operations, score generation operations, machine learning operations, machine learning training operations, or the like or combination thereof. More generally, the scope of the invention embraces any operating environment in which the disclosed concepts may be useful.

New and/or modified data collected and/or generated in connection with some embodiments, may be stored in a data environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method, comprising: receiving a new order for a product, assigning the new order to a cluster of orders based on features of the new order, wherein the assigned cluster includes orders that are most similar to the new order, generating a score for the new order based in part on the assigned cluster, wherein the score is a likelihood that the new order is a grey market order, and taking an action on the new order when the new order is a grey market order.

Embodiment 2. The method of embodiment 1, further comprising clustering historical data containing historical orders into a plurality of clusters including the cluster.

Embodiment 3. The method of embodiment 1 and/or 2, further comprising generating features from the historical data and inputting the features into a clustering engine, wherein the clustering engine generates the plurality of clusters from the features.

Embodiment 4. The method of embodiment 1, 2, and/or 3, wherein the features used for clustering the historical data include one or more of account industry, number of purchases, purchased line of businesses and quantity, average time between purchases, direct channel, commercial revenue, enterprise revenue, median purchase revenue, standard deviation of purchase revenue, number of employees, and buy power.

Embodiment 5. The method of embodiment 1, 2, 3, and/or 4, further comprising generating a score using features including one or more of product, quantity, price, discount, time since last purchase of the same product, last order quantity difference in percentage, mean and median of previous purchase quantities, and/or average time between purchases.

Embodiment 6. The method of embodiment 1, 2, 3, 4, and/or 5, wherein the score is based on a cosine similarity value between a feature vector for the new order and feature vectors for orders in the assigned cluster.

Embodiment 7. The method of embodiment 1, 2, 3, 4, 5, and/or 6, further wherein the new order is likely to be a grey market order when the score is above a threshold value.

Embodiment 8. The method of embodiment 1, 2, 3, 4, 5, 6, and/or 7, wherein clustering the historical data is performed using a probabilistic model including a gaussian mixture model.

Embodiment 9. The method of embodiment 1, 2, 3, 4, 5, 6, 7, and/or 8, further comprising generating the score using a KNN algorithm.

Embodiment 10. The method of embodiment 1, 2, 3, 4, 5, 6, 7, 8, and/or 9, wherein the action includes one or more of cancelling the order, changing a price of the order, taking no action, or limiting a quantity of the order.

Embodiment 11. A method for performing any of the operations, methods, or processes, or any portion of any of these or any combination thereof, disclosed herein.

Embodiment 12. A non-transitory storage medium having stored therein instructions that are executable by one or more hardware processors to perform operations comprising the operations of any one or more of embodiments 1 through 11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ or ‘engine’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

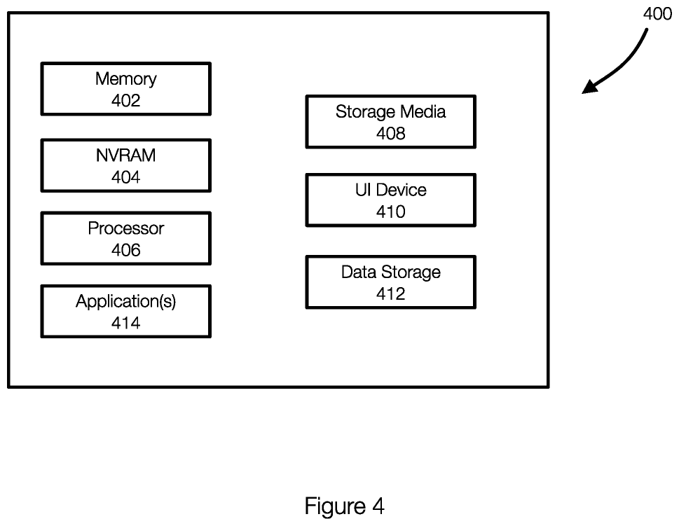

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random-access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid-state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a new order for a product;
assigning the new order to a cluster of orders based on features of the new order, wherein the assigned cluster includes orders that are most similar to the new order;
generating a score for the new order based in part on the assigned cluster, wherein the score is a likelihood that the new order is a grey market order; and
taking an action on the new order when the new order is a grey market order.

2. The method of claim 1, further comprising clustering historical data containing historical orders into a plurality of clusters including the cluster.

3. The method of claim 2, further comprising generating features from the historical data and inputting the features into a clustering engine, wherein the clustering engine generates the plurality of clusters from the features.

4. The method of claim 3, wherein the features used for clustering the historical data include one or more of account industry, number of purchases, purchased line of businesses and quantity, average time between purchases, direct channel, commercial revenue, enterprise revenue, median purchase revenue, standard deviation of purchase revenue, number of employees, and buy power.

5. The method of claim 1, further comprising generating a score using features including one or more of product, quantity, price, discount, time since last purchase of the same product, last order quantity difference in percentage, mean and median of previous purchase quantities, and/or average time between purchases.

6. The method of claim 1, wherein the score is based on a cosine similarity value between a feature vector for the new order and feature vectors for orders in the assigned cluster.

7. The method of claim 1, further wherein the new order is likely to be a grey market order when the score is above a threshold value.

8. The method of claim 2, wherein clustering the historical data is performed using a probabilistic model including a gaussian mixture model.

9. The method of claim 1, further comprising generating the score using a KNN algorithm.

10. The method of claim 1, wherein the action includes one or more of cancelling the order, changing a price of the order, taking no action, or limiting a quantity of the order.

11. A non-transitory storage medium having stored therein instructions that are executable by one or more hardware processors to perform operations comprising:
receiving a new order for a product;
assigning the new order to a cluster of orders based on features of the new order, wherein the assigned cluster includes orders that are most similar to the new order;
generating a score for the new order based in part on the assigned cluster, wherein the score is a likelihood that the new order is a grey market order; and
taking an action on the new order when the new order is a grey market order.

12. The non-transitory storage medium of claim 11, further comprising clustering historical data containing historical orders into a plurality of clusters including the cluster.

13. The non-transitory storage medium of claim 12, further comprising generating features from the historical data and inputting the features into a clustering engine, wherein the clustering engine generates the plurality of clusters from the features.

14. The non-transitory storage medium of claim 13, wherein the features used for clustering the historical data include one or more of account industry, number of purchases, purchased line of businesses and quantity, average time between purchases, direct channel, commercial revenue, enterprise revenue, median purchase revenue, standard deviation of purchase revenue, number of employees, and buy power.

15. The non-transitory storage medium of claim 11, further comprising generating a score using features including one or more of product, quantity, price, discount, time since last purchase of the same product, last order quantity difference in percentage, mean and median of previous purchase quantities, and/or average time between purchases.

16. The non-transitory storage medium of claim 11, wherein the score is based on a cosine similarity value between a feature vector for the new order and feature vectors for orders in the assigned cluster.

17. The non-transitory storage medium of claim 11, further wherein the new order is likely to be a grey market order when the score is above a threshold value.

18. The non-transitory storage medium of claim 12, wherein clustering the historical data is performed using a probabilistic model including a gaussian mixture model.

19. The non-transitory storage medium of claim 11, further comprising generating the score using a KNN algorithm.

20. The non-transitory storage medium of claim 11, wherein the action includes one or more of cancelling the order, changing a price of the order, taking no action, or limiting a quantity of the order.
